(19) United States
(12) Patent Application Publication
(10) Pub. No.: US 2011/0122174 A1
(43) Pub. Date: May 26, 2011

(54) COLOR ELECTRONIC PAPER USING RGBW COLOR PARTICLES AND DRIVING METHOD THEREOF

(75) Inventors: Soon Hyung Kwon, Seoul (KR); Won Keun Kim, Osan-si (KR); Jeong In Han, Seoul (KR); Chul Jong Han, Seoul (KR)

(73) Assignees: Korea Electronics Technology Institute; SK Telecom Co., Ltd.

(21) Appl. No.: 12/952,595

(22) Filed: Nov. 23, 2010

(30) Foreign Application Priority Data
Nov. 23, 2009 (KR) 10-2009-0113333

(51) Int. Cl. G09G 5/10

(52) U.S. Cl. 345/690

(57) ABSTRACT

A color electronic paper using RGBW color particles and a driving method thereof are provided.

The color electronic paper using RGBW color particles includes an upper substrate and a lower substrate spaced apart from each other; partitions disposed between the upper substrate and the lower substrate and forming a red subpixel, a green subpixel, a blue subpixel, and a transparent subpixel; a medium mixed with first charged particles and second charged particles and stored to the red subpixel, the green subpixel, the blue subpixel, and the transparent subpixel respectively; and a controller for applying the same voltage value as a smallest voltage value among voltage values applied to the red subpixel, the green subpixel, and the blue subpixel, to the transparent subpixel.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on, and assigned Serial No. 10-2009-0113333, the entire disclosure of which is hereby incorporated by reference.

### TECHNICAL FIELD OF THE INVENTION

The present invention relates generally to a color electronic paper using RGBW color particles and a driving method of the color electronic paper. More particularly, the present invention relates to a color electronic paper including an RGWB array using RGBW color particles for enhancing a color reproduction ratio of a color electronic paper panel by properly adjusting a voltage applied to a transparent subpixel, and a driving method of the color electronic paper.

### BACKGROUND OF THE INVENTION

Electronic papers are estimated as a next-generation reflective display device having characteristics different from liquid crystal displays, plasma display panels, and organic electro luminescence devices.

A recent electronic paper under development seals positively charged particles and negatively charged particles together in air within a single cell. Mostly, black particles are positively charged and white particles are negatively charged. The positively charged particles and negatively charged particles sealed migrate vertically between upper and lower substrates according to an applied voltage to thus represent various texts and images. Since the charged particles can be regenerated for millions of times, it is anticipated that the electronic paper will replace the existing print media such as books, newspapers, and magazines.

A color electronic paper using RGB color particles fulfills a display function by reflecting only 33% of ambient light. Accordingly, the reflectivity is quite low. To overcome the low reflectivity, an RGBW pattern is used to raise the overall reflectivity. According to blackness or whiteness of a white pixel, the image representation visibility of the whole panel varies.

FIG. 1 is a sectional view of a conventional color electronic paper having the RGBW pattern.

FIG. 1 depicts particle distribution when white pixels realize 100% white and 100% black in the color electronic paper having the RGBW pattern.

In each subpixel including an upper substrate 1, a lower substrate 2, and a partition 5, a transparent electrode 4 is formed on the side of the upper substrate 1. Charged particles 4 and 6 in the subpixels drive the electronic paper.

In FIG. 1, the transparent subpixel reproduces all white (FIG. 1A) or all black (FIG. 1B) and thus increases whiteness or blackness of the whole panel. In this case, the visibility of the color image representation degrades and the whole panel can be viewed darkly or whitely.

FIG. 2 is a sectional view of a conventional color electronic paper using collision electrification. FIG. 3 is a plane view of operations of a general color electronic paper.

Referring to FIGS. 2 and 3, the color electronic paper using a color filter includes a color filter 19 on a first side of a first base layer, an upper substrate 11 having an upper transparent electrode 12 patterned on the color filter 19, a lower substrate 18 including a lower transparent electrode 17 patterned on a second side of a second base layer facing the first side of the upper substrate 11, and a partition 13 for separating the subpixels, and a medium 14 in each subpixel between the upper transparent electrode 12 of the upper substrate 11 and the lower transparent electrode 17 of the lower substrate 18. Charged particles 15 of a first polarity and charged particles 16 of a second polarity are scatted in the medium 14.

The upper substrate 11 which is the first base layer can be formed of either plastic or glass, and the color filter 19 is deposited in a side (the first side) of the upper substrate. The upper transparent electrode 12 for applying a driving voltage of the device is patterned on the color filter layer 19. Herein, the color filter 19 includes a matrix 19a for blocking the light and separating filtering regions including a red (R) color, a green (G) color, a blue (B) color, and a transparent part W. The matrix, which is a white matrix for reproducing the white when the power is turned off, is formed to correspond to the partition which separates the subpixels.

When the color electronic paper using the color filter in FIG. 2 drives, the dark or white panel due to the degraded visibility of the color image reproduction can be addressed to some degree. Still, it is hard to reproduce various colors in the white subpixel which is the transparent subpixel.

### SUMMARY OF THE INVENTION

To address the above-discussed deficiencies of the prior art, it is a primary aspect of the present invention to provide a color electronic paper including an RGWB array using RGBW color particles for addressing whiteness degradation of the color electronic paper which reproduces colors using the color particles instead of a color filter, and providing an optimum representation of an original image with higher image visibility by properly adjusting a voltage applied to a transparent subpixel, and a driving method of the color electronic paper.

According to one aspect of the present invention, a color electronic paper using RGBW color particles includes an upper substrate and a lower substrate spaced apart from each other; partitions disposed between the upper substrate and the lower substrate and forming a red subpixel, a green subpixel, a blue subpixel, and a transparent subpixel; a medium mixed with first charged particles and second charged particles and stored to the red subpixel, the green subpixel, the blue subpixel, and the transparent subpixel respectively; and a controller for applying the same voltage value as a smallest voltage value among voltage values applied to the red subpixel, the green subpixel, and the blue subpixel, to the transparent subpixel.

The first charged particles may include a first red color particle stored to the red subpixel; a first green color particle stored to the green subpixel; and a first blue color particle stored to the blue subpixel.

The first charged particles may include a first white particle or a first black particle stored to the transparent subpixel.

The second charged particles may include a second white particle or a second black particle stored to each of the red subpixel, the green subpixel, the blue subpixel, and the transparent subpixel.

The second charged particles may include a second red color particle, a second green color particle, and a second blue color particle stored to the transparent subpixel.

The first charged particles stored to each of the red subpixel, the green subpixel, the blue subpixel, and the transparent subpixel may have the same polarity.

A polarity of the first charged particles and a polarity of the second charged particles may be different from each other.

The medium may be a gas.

According to another aspect of the present invention, a method for driving a color electronic paper using RGBW color particles is provided. The color electronic paper includes a red subpixel, a green subpixel, a blue subpixel, and a transparent subpixel between an upper substrate and a lower substrate, and a medium mixed with first charged particles and second charged particles and stored to the red subpixel, the green subpixel, the blue subpixel, and the transparent subpixel respectively. A pattern constituted with the red subpixel, the green subpixel, the blue subpixel, and the transparent subpixel forms a color array using the first charged particles, and a voltage applied to the transparent subpixel is the same as voltages to the red subpixel, the green subpixel, and the blue subpixel respectively.

The first charged particles may include a first red color particle stored to the red subpixel; a first green color particle stored to the green subpixel; and a first blue color particle stored to the blue subpixel.

The first charged particles may include a first white particle or a first black particle stored to the transparent subpixel.

The second charged particles may include a second white particle or a second black particle stored to each of the red subpixel, the green subpixel, the blue subpixel, and the transparent subpixel.

The second charged particles may include a second red color particle, a second green color particle, and a second blue color particle stored to the transparent subpixel.

The first charged particles stored to each of the red subpixel, the green subpixel, the blue subpixel, and the transparent subpixel may have the same polarity.

A polarity of the first charged particles and a polarity of the second charged particles may be different from each other.

The color electronic paper may be an electronic paper using collision electrification.

The medium may be a gas.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a sectional view of a conventional color electronic paper having a RGBW pattern;

FIG. 2 is a sectional view of a conventional color electronic paper using collision electrification;

FIG. 3 is a plane view of operations of a general color electronic paper;

FIG. 4 is a sectional view of a color electronic paper using RGBW color particles according to an exemplary embodiment of the present invention; and

FIG. 5 is a sectional view of a color electronic paper using the RGBW color particles according to another exemplary embodiment of the present invention.

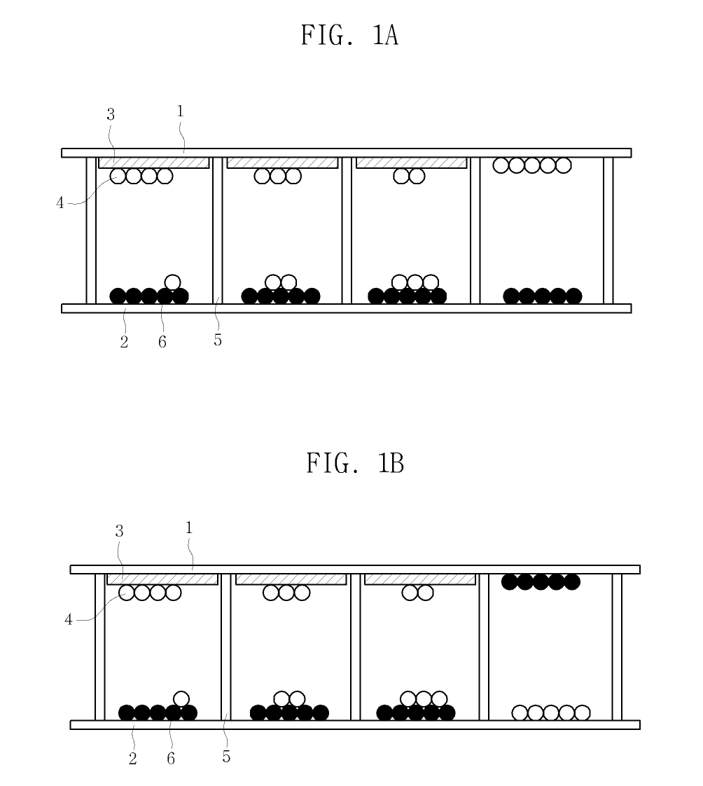

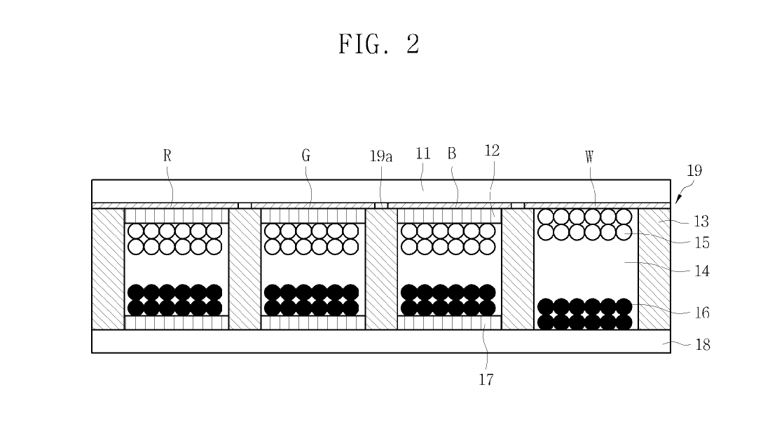

Throughout the drawings, like reference numerals will be understood to refer to like parts, components and structures.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

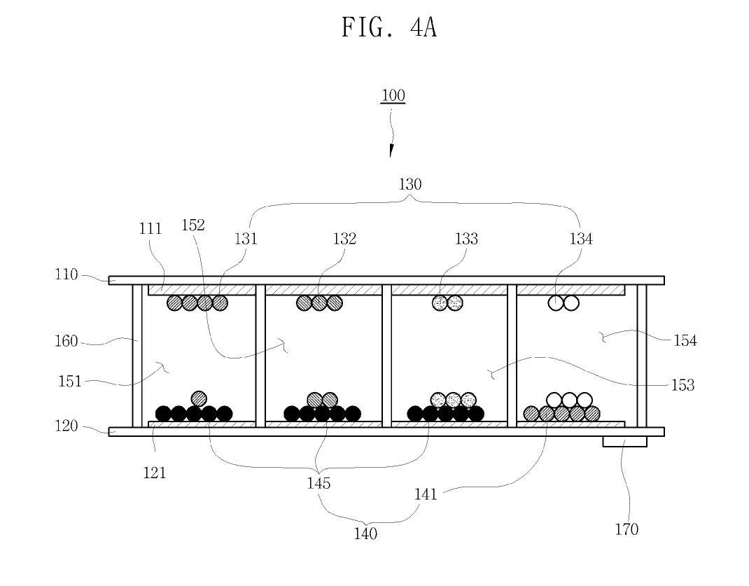

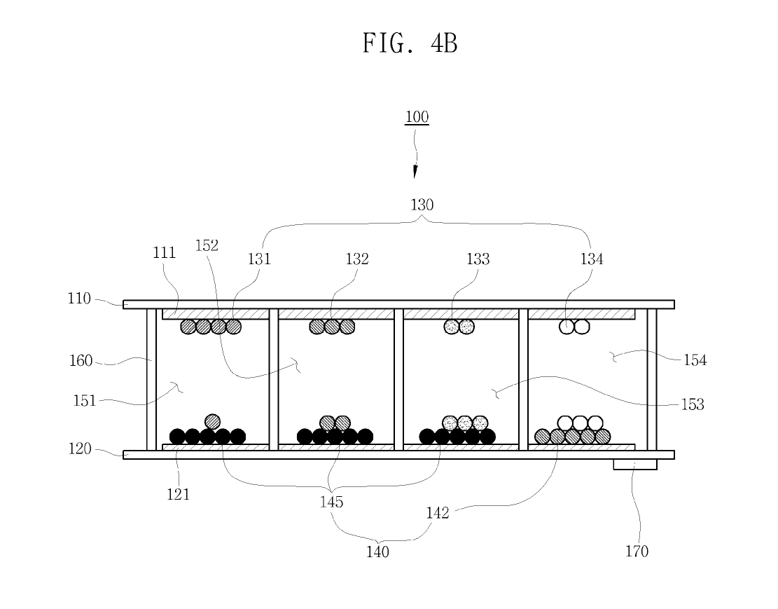

FIG. 4 is a sectional view of a color electronic paper 100 using RGBW color particles according to an exemplary embodiment of the present invention.

Referring to FIG. 4, the color electronic paper 100 using RGBW color particles (hereafter, referred to as a color electronic paper for simplicity) includes an upper substrate 110 and a lower substrate 120 spaced apart from each other. The upper substrate 110 and the lower substrate 120 can be formed of various materials. The upper substrate 110 and the lower substrate 120 can be formed of a transparent material. For example, the upper substrate 110 and the lower substrate 120 can be formed of either plastic or glass.

The upper substrate 110 can include an upper transparent electrode 111 formed in one side. The lower substrate 120 can include a lower transparent electrode 121 formed in one side.

The upper transparent electrode 111 can be disposed to face the lower transparent electrode 121. The upper transparent electrode 111 and the lower transparent electrode 121 can generate an electrical potential difference by applying different voltages from outside.

The color electronic paper 100 includes a partition 160 interposed between the upper substrate 110 and the lower substrate 120. The partitions 160 can be spaced apart to separate a red subpixel 151, a green subpixel 152, a blue subpixel 153, and a transparent subpixel 154.

The color electronic paper 100 includes a medium (not shown) mixed with first charged particles 130 and second charged particles 140. The medium mixed with the first charged particles 130 and the second charged particles 140 can be stored to the subpixels 151 through 154.

The first charged particles 130 can include a first red color particle 131 stored to the red subpixel 151, a first green color particle 132 stored to the first green subpixel 152, and a first blue color particle 133 stored to the blue subpixel 153.

The first charged particles 130 can include a first white particle 134 or a first black particle (not shown) stored to the transparent subpixel 154. The first charged particles 130 can be stored to the subpixels 151 through 154 variously according to a user's selection.

The first charged particles 130 stored to the subpixels 151 through 154 can have the same polarity. Hence, the user can implement various color electronic papers 100 according to state, use, and purpose of the color electronic paper 100.

The second charged particles 140 can include second white particles (not shown) or second black particles (not shown) stored to the red subpixel 151, the green subpixel 152, the blue subpixel 153, and the transparent subpixel 154 respectively. The second white particle and the second black particle can be formed of the same material as the first white particle 134 and the first black particle respectively.

The second charged particles 140 can include one of a second red color particle 141, a second green color particle 142, and a second blue color particle (not shown), which is stored to the transparent subpixel 154. The second red color particle 141, the second green color particle 142, and the second blue color particle can be formed the same as the first red color particle 131, the first green color particle 132, and the first blue color particle 133 described above.

The first charged particles 130 and the second charged particles 140 can have different polarities. Accordingly, it is possible to form various patterns according to the potential difference generated between the upper transparent electrode 111 and the lower transparent electrode 121.

The color electronic paper 100 includes a controller 170 for controlling the voltage values applied to the subpixels 151 through 154. The controller 170 can detect the voltage values applied to the red subpixel 151, the green subpixel 152, and the blue subpixel 153. The controller 170 can control the voltage value of the transparent subpixel 154 based on the detected voltage value.

To fabricate the color electronic paper 100, one side of the upper substrate 110 is patterned to apply a driving voltage of the device to the upper transparent electrode 111. Similar to the upper transparent electrode 111, one side of the lower substrate 120 is patterned to apply a driving voltage of the device to the lower transparent electrode 121. The upper transparent electrode 111 and the lower transparent electrode 121 can be formed to face each other as stated above.

The upper substrate 110 and the lower substrate 120 constructed as above are spaced apart using the partitions 160 while facing each other, a sealant is spread over edges of them, the medium of the gas including the first charged particles 130 and the second charged particles 140 of the different polarities is injected into the subpixels 151 through 154 partitioned by the upper transparent electrode 111, the lower transparent electrode 121, and the partitions 160, and thus the color electrode paper 100 is fabricated.

Herein, the first charged particles 130 and the second charged particles 140 can be coated with a material, such as silica, including a surface charge control agent and charged to either the positive (+) polarity or the negative (−) polarity. In so doing, the first charged particles 130 can be charged with the first polarity (for example, the negative (−) polarity), and the second charged particles 140 can be charged with the second polarity (for example, the positive (+) polarity). Conversely, the first charged particles 130 and the second charged particles 140 can be charged with the opposite polarities.

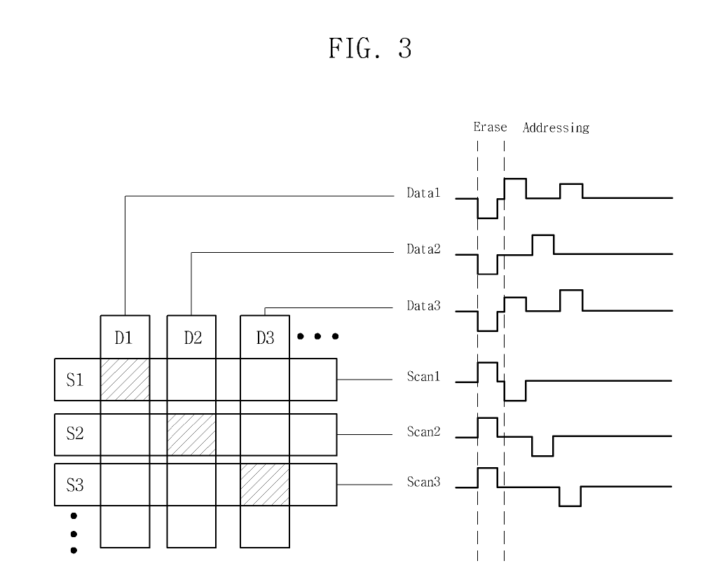

Meanwhile, the driving method of the subpixels 151 through 154 is the same as a general passive matrix driving method. As shown in FIG. 3, a scan voltage (upper electrode) is applied to S1 through SN, a data voltage (lower electrode) is applied to D1 through DN at the same time, and thus the particles are driven by the potential difference of the subpixels 151 through 154 facing each other.

The present invention features no use of the color filter in the conventional color array and the color reproduction in the subpixels 151 through 154 using the first charged particles 130.

The transparent subpixel 154 can be filled with the second red color particle 141, the second green color particle 142, or the second blue color particle, rather than the second white particle or the second black particle, as the second charged particles 140. Advantageously, by inserting the second red color particle 141, the second green color particle 142, or the second blue color particle, which is the second charged particle 140, into the transparent subpixel 154, a specific color can be emphasized according to the purpose of the panel.

Referring to FIG. 4A, the first red color particle 131 attaching to the upper substrate 110 in the red subpixel 151 reproduces the red. To emphasize the red of the low brightness, the red in the whole panel can be emphasized by injecting the second red color particle 141 together with the first white particle 134 into the transparent subpixel 154.

Likewise, the first green color particle 132 attaching to the upper substrate 110 in the green subpixel 152 reproduces the green as shown in FIG. 4B. To emphasize the green, the green in the whole panel can be emphasized by injecting the second green color particle 142 together with the first white particle 134 into the transparent subpixel 154.

Thus, the color electronic paper 100 can reproduce various colors to fit for the operation environment and the purpose of the color electronic paper 100.

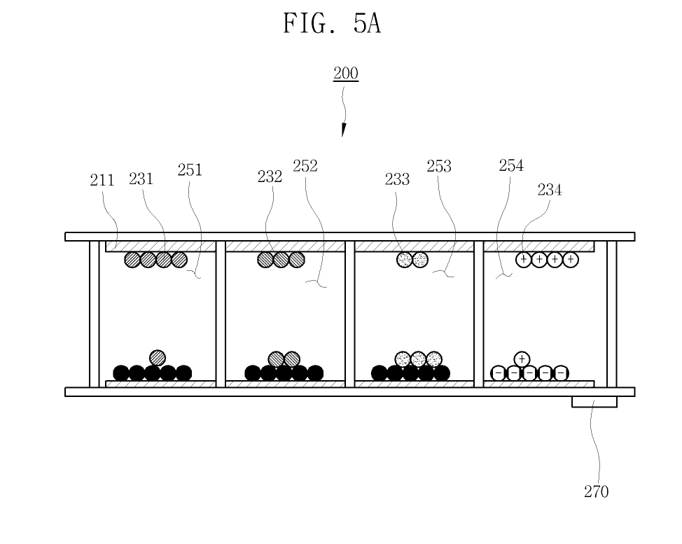

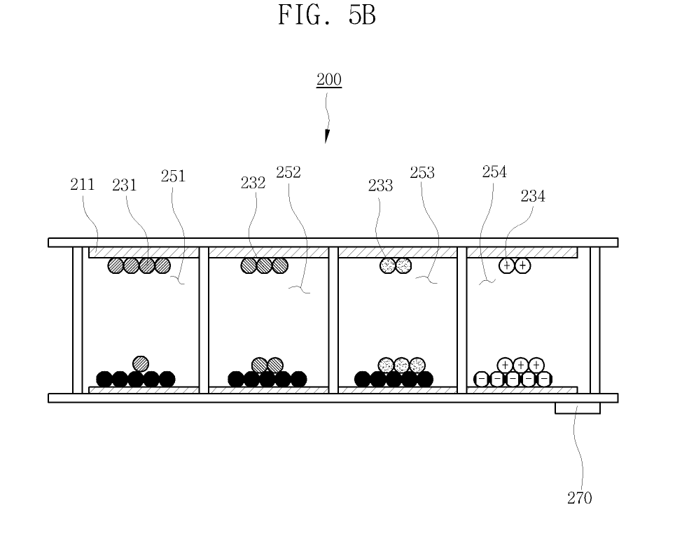

FIG. 5 is a sectional view of a color electronic paper 200 using the RGBW color particles according to another exemplary embodiment of the present invention.

FIG. 5A depicts a transparent subpixel 254 formed with the same voltage value as in a red subpixel 254 of the greatest whiteness among the RGB, and FIG. 5B depicts the transparent subpixel 254 formed with the same voltage value as in a blue subpixel 253 of the smallest whiteness among the RGB.

Referring to FIG. 5, when the color electronic paper 200 operates, the controller 270 can detect voltage values applied to the red subpixel 251, a green subpixel 252, and the blue subpixel 253. The controller 270 can compare the voltage values applied to the red subpixel 251, the green subpixel 252, and the blue subpixel 253.

Based on the comparison, the controller 270 can select the smallest voltage value from the voltage values of the red subpixel 251, the green subpixel 252, and the blue subpixel 253. Based on the smallest voltage value, the controller 270 can control the voltage value of the transparent subpixel 254. That is, the controller 270 can control to make the smallest voltage value and the voltage value applied to the transparent subpixel 254 the same.

As the controller 270 operates as above, experiments prove the best color characteristics when the transparent subpixel 254 is applied with the same voltage value as the subpixel of the smallest whiteness (FIG. 5B) among the results of applying different voltage values to the transparent subpixel 254.

For example, provided that the voltage applied to the subpixels 251 through 254 varies the white reflectivity, 25V is applied to the red subpixel 251, 30V is applied to the blue subpixel 253, and 10V is applied to the green subpixel 252, a first red color particle 231, a first green color particle 232, and a first blue color particle 233 migrate to an upper transparent electrode 211.

At this time, when the controller 270 applies the same voltage 10V to the transparent subpixel 254 as in the green subpixel 252, first white particles 234 as many as the first green color particles 232 float. The color electronic paper 200 can reproduce the most natural colors and achieve the optimal representation close to the original image by raising the image visibility. During the experiments, the color electronic paper 200 controls the controller 270 to apply 25V or 30V to the transparent subpixel 254.

According to the experiments, when the original image is compared with the image adopting the present driving method, the visibility and the original image representation are enhanced over 50%.

Thus, the color electronic paper 200 can provide the optimal visibility and original image representation. Also, the color electronic paper 200 can operate in the optimized conditions with ease and with rapidity.

In the light of the foregoing, the color electronic paper using the RGBW color array with the color particles can reproduce the optimal colors by properly adjusting the voltage applied to the transparent subpixel, and provide the optimal representation of the original image by raising the image visibility.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A color electronic paper using RGBW color particles, comprising:
an upper substrate and a lower substrate spaced apart from each other;
partitions disposed between the upper substrate and the lower substrate and forming a red subpixel, a green subpixel, a blue subpixel, and a transparent subpixel;
a medium mixed with first charged particles and second charged particles and stored to the red subpixel, the green subpixel, the blue subpixel, and the transparent subpixel respectively; and
a controller for applying the same voltage value as a smallest voltage value among voltage values applied to the red subpixel, the green subpixel, and the blue subpixel, to the transparent subpixel.

2. The color electronic paper of claim 1, wherein the first charged particles comprise:
a first red color particle stored to the red subpixel;
a first green color particle stored to the green subpixel; and
a first blue color particle stored to the blue subpixel.

3. The color electronic paper of claim 1, wherein the first charged particles comprise a first white particle or a first black particle stored to the transparent subpixel.

4. The color electronic paper of claim 1, wherein the second charged particles comprise a second white particle or a second black particle stored to each of the red subpixel, the green subpixel, the blue subpixel, and the transparent subpixel.

5. The color electronic paper of claim 1, wherein the second charged particles comprise a second red color particle, a second green color particle, and a second blue color particle stored to the transparent subpixel.

6. The color electronic paper of claim 1, wherein the first charged particles stored to each of the red subpixel, the green subpixel, the blue subpixel, and the transparent subpixel have the same polarity.

7. The color electronic paper of claim 1, wherein a polarity of the first charged particles and a polarity of the second charged particles are different from each other.

8. The color electronic paper of claim 1, wherein the medium is a gas.

9. A method for driving a color electronic paper using RGBW color particles, the color electronic paper comprising a red subpixel, a green subpixel, a blue subpixel, and a transparent subpixel between an upper substrate and a lower substrate, and a medium mixed with first charged particles and second charged particles and stored to the red subpixel, the green subpixel, the blue subpixel, and the transparent subpixel respectively,
wherein a pattern constituted with the red subpixel, the green subpixel, the blue subpixel, and the transparent subpixel forms a color array using the first charged particles, and a voltage applied to the transparent subpixel is the same as voltages to the red subpixel, the green subpixel, and the blue subpixel respectively.

10. The method of claim 9, wherein the first charged particles comprise:
a first red color particle stored to the red subpixel;
a first green color particle stored to the green subpixel; and
a first blue color particle stored to the blue subpixel.

11. The method of claim 9, wherein the first charged particles comprise a first white particle or a first black particle stored to the transparent subpixel.

12. The method of claim 9, wherein the second charged particles comprise a second white particle or a second black particle stored to each of the red subpixel, the green subpixel, the blue subpixel, and the transparent subpixel.

13. The method of claim 9, wherein the second charged particles comprise a second red color particle, a second green color particle, and a second blue color particle stored to the transparent subpixel.

14. The method of claim 9, wherein the first charged particles stored to each of the red subpixel, the green subpixel, the blue subpixel, and the transparent subpixel have the same polarity.

15. The method of claim 9, wherein a polarity of the first charged particles and a polarity of the second charged particles are different from each other.

16. The method of claim 9, wherein the color electronic paper is an electronic paper using collision electrification.

17. The method of claim 9, wherein the medium is a gas.
